(19) United States
(12) Patent Application Publication
(10) Pub. No.: US 2013/0321239 A1
(43) Pub. Date: Dec. 5, 2013

(54) Three Dimensional Antenna Array System with Troughs

(71) Applicant: Aereo, Inc., Long Island City, NY (US)

(72) Inventor: James Alan Bingham, Westerville, OH (US)

(21) Appl. No.: 13/904,240

(22) Filed: May 29, 2013

Related U.S. Application Data
(60) Provisional application No. 61/652,728, filed on May 29, 2012.
(60) Provisional application No. 61/652,742, filed on May 29, 2012.

(51) Int. Cl. H01Q 1/24; H01Q 21/28

(52) U.S. Cl. CPC H01Q 1/24; H01Q 21/28
USPC 343/879

(57) ABSTRACT

A system and method for installing and deploying antenna elements on antenna arrays cards is disclosed. The antenna elements are installed on front sides of the antenna array cards and active components are installed on back sides of the antenna array cards. The antenna array cards are then installed within enclosures to create troughs with the antenna elements. Alternatively, magnetic and electric antenna elements are installed together on the front sides of the antenna array cards to create non-homogenous arrays.

### RELATED APPLICATIONS

This application claims the benefit under 35 U.S.C. §119(e) of U.S. Provisional Application No. 61/652,728, filed on May 29, 2012, and U.S. Provisional Application No. 61/652,742, filed on May 29, 2012, both of which are incorporated herein by reference in their entirety.

### BACKGROUND OF THE INVENTION

Recently, systems including arrays of small radio frequency (RF) antennas have been deployed for capturing over the air or RF broadcast content, such as broadcast (terrestrial) television, under the control of the users. These systems then stream the captured content to users via public data networks, such as the Internet. An example of a system for capturing and streaming over the air content to users via the Internet is described in, “System and Method for Providing Network Access to Antenna Feeds” by Kanojia et al., filed Nov. 17, 2011, U.S. patent application Ser. No. 13/299,186 (U.S. Patent Publication Number: US 2012/0127374 A1), which is incorporated herein by reference in its entirety.

In these systems, each user is typically assigned an individual antenna element. As a consequence, the systems implement arrays of antenna elements with large numbers of physically small antenna elements installed on antenna array cards (e.g., printed circuit boards). In order to maximize the number of antenna elements in the system, the antenna array cards are preferably arranged to form three dimensional arrays.

In operation, the antenna elements are tuned to capture over the air content that is broadcast from different broadcasting entities. The captured over the air content is then demodulated and sent to an encoding system to be transcoded and stored and/or streamed to client devices.

In the past, the antenna elements, tuners, demodulators, and communication components were installed on the same side of the antenna array cards. The antenna elements were installed in the antenna array sections; the tuners and demodulators were installed in separate tuner/demodulator sections. The antenna array cards were then installed within an enclosure with only the antenna sections and their antenna elements protruding from the enclosure.

### SUMMARY OF THE INVENTION

In these previous implementations, most of the available space on the antenna array cards was needed for the tuners, demodulators, and communication components. This configuration resulted in the antenna elements being mounted on a small fraction of the area of each antenna array card, which limited the number of antenna elements that could be installed on the antenna array cards and the total number of elements in the system. For example, the previous implementation typically only had 80 antenna elements per antenna array card despite the size of the cards.

Also in these previous implementations, the antenna elements were sometimes located as much as twenty inches (0.5 meters) or more from corresponding tuners and demodulators. Thus, the antenna array cards needed long transmission lines to carry signals from the antenna elements to the tuners and demodulators. These long transmission lines are problematic because they are vulnerable to unwanted interference generated by active components (e.g., the tuners and demodulators) installed on the antenna array cards. Additionally, the transmission lines also create interference that can affect other transmission lines.

In general, the present solutions are directed to increasing the number of antenna elements installed or mounted on each antenna array card and/or eliminating long transmission lines on the antenna array cards. The current solution is able to hold more antenna elements and can avoid requiring long transmission lines routed throughout the antenna array cards.

In one solution, antenna elements are installed on front sides of the antenna array cards and the corresponding tuners and demodulators are installed on back sides of the antenna array cards. Additionally, the antenna array cards are installed back to back within an enclosure to form troughs with antenna elements possibly on both sides of the troughs.

In other aspects, the antenna array cards include non-homogenous arrays on the antenna array cards. The non-homogenous arrays include electric and magnetic antenna elements. This deployment of non-homogenous arrays roughly doubles the usable volume for antenna element placement (especially when the arrays are ground plane backed).

In general, according to one aspect, the invention features an antenna system for capturing over the air broadcasts. The antenna system includes antenna array cards that have an array of antenna elements disposed on a front side of the cards. The antenna elements are separately tuned to receive over the air broadcasts from broadcasting entities. The system further includes an enclosure that houses the antenna array cards and forms troughs with the antenna elements on sides of the troughs.

In embodiments, the antenna array cards are installed back to back within the enclosure and the enclosure houses between 6 and 32 antenna array cards.

In some examples, the troughs extend entirely through the enclosure. In other examples, the antenna array cards include ground planes to reflect the radio frequency signals from the broadcasting entities.

Tuners, demodulators, multiplexors, and data link connectors are preferably provided on the antenna array cards. The tuners and demodulators are disposed on back sides of the antenna array cards and correspond to the antenna elements disposed on front sides of the cards.

Some embodiments include a radio frequency signal absorbers to prevent reflection of radio waves off walls of the enclosure.

In general, according to another aspect, the invention features a method of capturing over the air broadcasts from broadcasting entities. The method includes having antenna array cards that include antenna elements disposed on one side of the cards. The method further includes antenna elements separately receiving over the air broadcasts from broadcasting entities and arranging the antenna array cards within an enclosure to form troughs with the antenna elements on sides of the troughs.

In general, according to another aspect, the invention features an antenna array card. The antenna array card includes an array of antenna elements disposed on a front side of the cards and corresponding tuners and demodulators disposed on a back side of the card. Additionally, the antenna elements are separately tuned by the tuners to receive over the air broadcasts from broadcasting entities.

In general, according to another aspect, the invention features an antenna system comprising antenna array cards, which each include an array of antenna elements disposed on a front side of the cards. The antenna elements are separately tuned to receive over the air broadcasts from different broadcasting entities. The antenna system also includes an enclosure that positions the antenna array cards back to back within the enclosure to form troughs with the antenna elements on opposed sides of the troughs.

In general, according to another aspect, the invention features an antenna system comprising antenna array cards that include an array of electric and magnetic antenna elements. Additionally, the magnetic antenna elements are preferably installed on the antenna array cards closer to a ground plane than the electric antenna elements.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a perspective schematic view of a three dimensional antenna array including troughs formed by the installation of antenna array cards within an enclosure.

FIG. 2 is a perspective view of multiple three dimensional antenna array systems installed in a rack.

FIG. 3 is a schematic cross-sectional view (top view) of the three dimensional antenna array including the troughs.

FIG. 4A is a schematic diagram illustrating a front side of the antenna array card.

FIG. 4B is a schematic diagram illustrating a back side of the antenna array card.

FIG. 5 is a perspective schematic view of a second embodiment of the three dimensional antenna array, which includes troughs extending through the enclosure.

FIG. 6 is a schematic cross-sectional view (top view) of the second embodiment of the three dimensional antenna array.

FIG. 7 is a schematic diagram illustrating an alternative embodiment of the antenna array cards and enclosure.

FIG. 8 is a schematic cross-sectional view (top view) of a non-homogeneous three dimensional antenna array including troughs formed by the antenna array cards.

FIG. 9A illustrates a front side of the antenna array card including electric antenna and magnetic antenna elements.

FIG. 9B illustrates the backside of the antenna array card with the non-homogeneous antenna array.

FIG. 10 is a block diagram illustrating an encoding system for the encoding of captured over the air content broadcasts.

FIG. 11 shows relative gains for electric and magnetic elements from a ground plane.

### DETAILED DESCRIPTION OF THE PREFERRED EMBODIMENTS

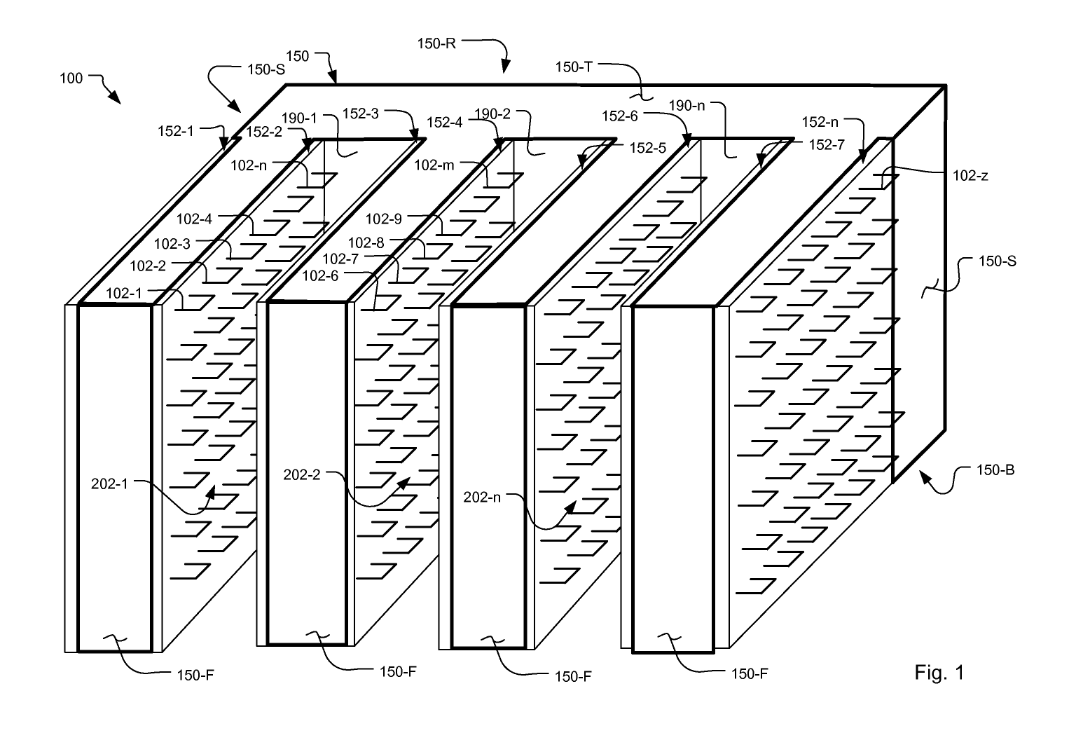

FIG. 1 is a perspective schematic view of a three dimensional antenna array system 100 including troughs 202-1 to 202-n formed by the installation of antenna array cards 152-1 to 152-n within an enclosure 150.

In a preferred embodiment, the antenna arrays cards 152-1 to 152-n are installed (or possibly fabricated) back to back to create double boards or super boards. The antenna arrays cards 152-1 to 152-n are arranged to form troughs 202-1 to 202-n with antenna elements 102-1 to 102-n, 102-6 to 102-m . . . 102-z on opposed sides of the troughs 202-1 to 202-n, in one embodiment.

This configuration enables the RF transmissions, which encode the over the air broadcasts from the broadcasting entities, to travel down the troughs 202-1 to 202-n and be received by the antenna elements 102-1 to 102-z installed on each of the antenna array cards 152-1 to 152-n.

In an alternative embodiment, the antenna array cards are all installed in the same direction (i.e., not back to back). In this case, the antenna elements would only be arrayed on one lateral side of each of the troughs 202-1 to 202-n.

Typically, each enclosure 150 is capable of housing between 6 and 32 antenna array cards to form between 3 and 16 troughs. Alternative embodiments of the enclosure may house greater or fewer antenna array cards, however.

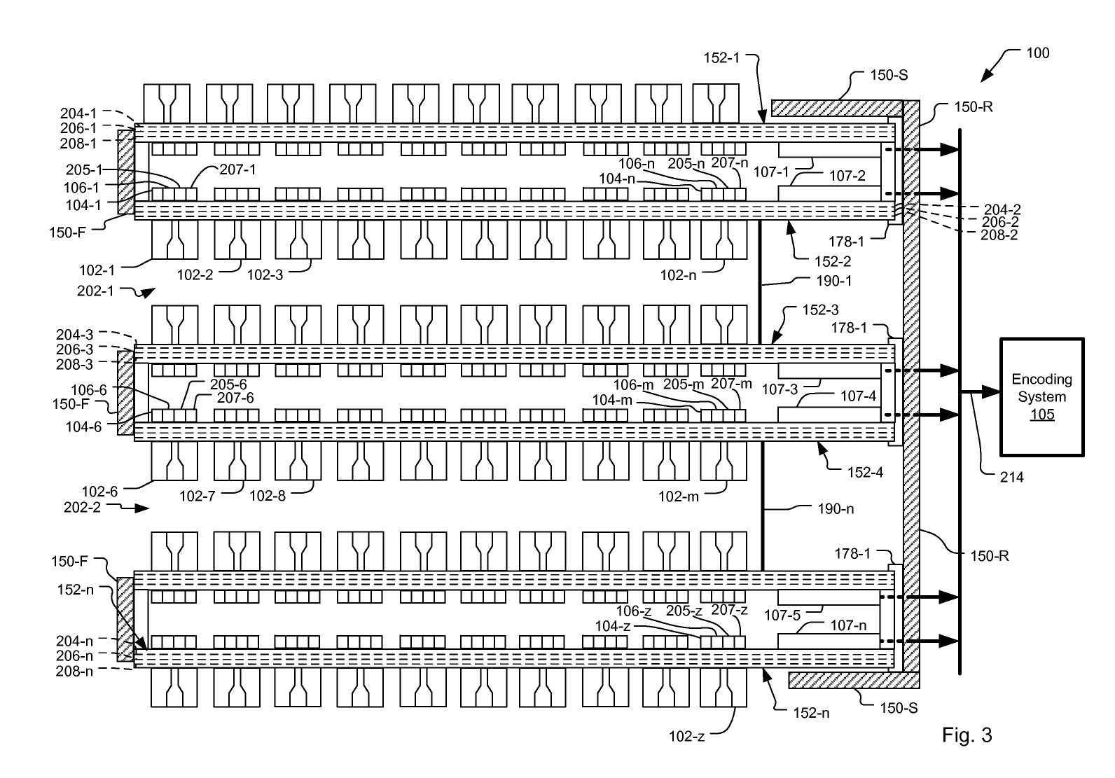

The side walls 150-S, top wall 150-T, bottom wall 150-B, front walls 150-F, and rear wall 150-R of the enclosure 150 are fabricated from conductive materials to maximize Faraday shielding between the antenna elements 102-1 to 102-n and the active components (e.g., tuners 104-1 to 104-z and demodulators 106-1 to 106-z) and the tuning sections 205-1 to 205-z, 207-1 to 207-z shown in FIG. 3, which are installed on back sides of the antenna array cards.

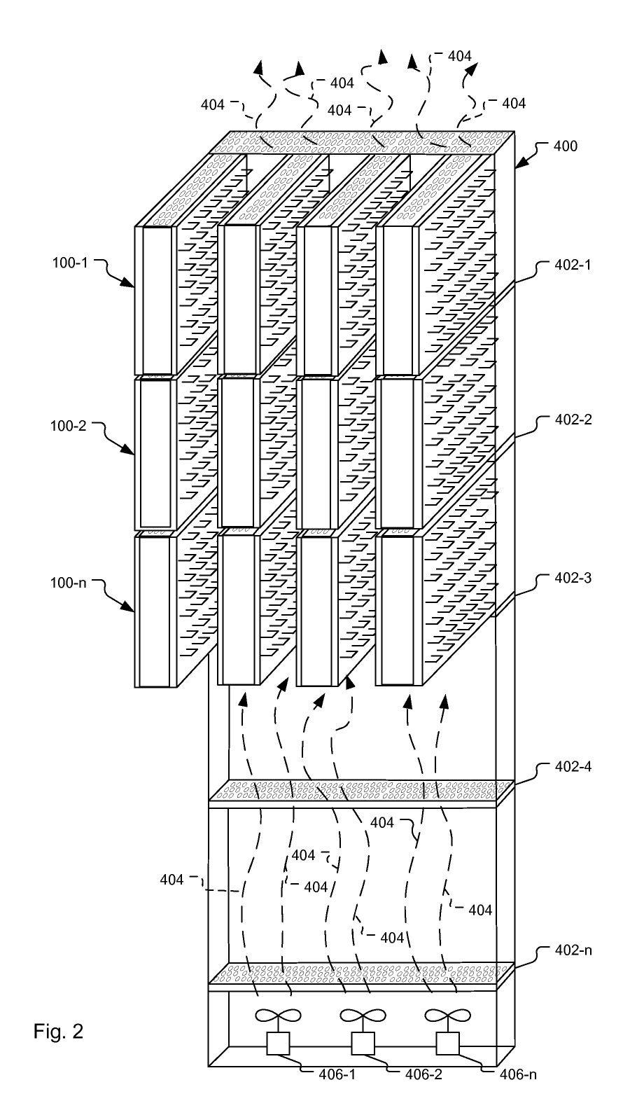

In a preferred embodiment, the top 150-T and bottom 150-B of the enclosure 150 are fabricated from metal mesh (shown in FIG. 2) and/or other similar semi-permeable materials that provide electrical shielding while allowing air to pass through the material. Additionally, the side walls of the enclosure 150-S may also be fabricated from metal mesh or include vents and/or louvers to further dissipate heat generated by the components of the antenna array system 100.

In a typical implementation, the enclosure 150 further includes RF signal absorber blocks 190-1 to 190-n at the end of each trough 202-1 to 202-n to absorb RF signals and prevent the RF signals from reflecting off the walls at the end of the troughs and creating (unwanted) destructive interference.

FIG. 2 is a perspective view of antenna array systems 100-1 to 100-n, as described with reference to FIG. 1, installed in a rack 400.

In the illustrated example, the rack 400 is a vertical frame that includes supports (e.g., shelves) 402-1 to 402-n. The supports 402-1 to 402-n carry the antenna array systems 100-1 to 100-n installed within the rack. In the preferred embodiment, the shelves are also fabricated from metal mesh. Typically, the rack 400 includes a sub-framework (e.g., rails or slides) that enable the antenna array systems 100-1 to 100-n to be fastened to the rack 400 with screws or bolts, for example.

In a typical implementation, fans 406-1 to 406-n are installed at the bottom of the rack 400 to force air through the metal mesh of the shelves 402-1 to 402-n and the tops and bottoms walls of the enclosures. While the illustrated example shows only three fans installed at the bottom of the rack, a typical implementation might likely include a greater number of fans. For example, multiple fans may be installed under each shelf of the rack and/or built into the walls of the enclosures 150 of each antenna array system 100-1 to 100-n.

In alternative embodiments, additional cooling systems such as liquid-based chiller systems or air conditioning systems are utilized to remove/dissipate the heat generated by the components of the antenna array systems 100-1 to 100-n.

FIG. 3 is a hybrid schematic and block diagram (cross-sectional top view) of the three dimensional antenna array 100 showing the troughs 202-1 to 202-n formed by the installation of the antenna array cards 152-1 to 152-n within an enclosure 150.

For illustrative purposes, the top wall 150-T is not shown. From this view, only a single row of antenna elements and corresponding active components and tuning sections are shown because the antenna elements, active components, and tuning sections are installed in a grid of rows and columns on the antenna array cards. Thus, the other components installed on the board are not visible because they are “lined up” behind the illustrated antenna elements, active components, and tuning sections.

To preserve clarity within the figures, only some of the antenna elements 102-1 to 102-z, tuners 104-1 to 104-z, demodulators 106-1 to 106-z, and tuning sections 205-1 to 205-z, 207-1 to 205-z are labeled in the figure. However, as illustrated, there are corresponding active components and tuning sections for each antenna element.

In a current implementation, the antenna array cards 152-1 to 152-n are printed circuit boards fabricated from dielectric insulator materials known in the art. These printed circuit boards are comprised of numerous layers of conductive pathways (or traces), power planes, and/or ground planes, to list a few examples. For illustrative purposes, dotted lines 204-1 to 204-n, 206-1 to 206-n, and 208-1 to 208-n are shown to represent these many different layers of the antenna array cards 152-1 to 152-n.

The antenna array cards 152-1 to 152-n are secured within the enclosure 150 with fasteners or locking tabs 178-1 to 178-n. Typically, the locking tabs 178-1 to 178-n are secured to the rear wall 150-R of the enclosure.

The antenna array cards 152-1 to 152-n are generally orientated vertically within the enclosure 150, with the antenna elements 102-1 to 102-z orientated horizontally to create a horizontally polarized (Electric Field) half omni-directional antenna array. Alternatively, if the broadcast content from the broadcasting entities has a vertical polarization, which occurs in some locales, then the orientation of the antenna array cards 152-1 to 152-n and antenna elements 102-1 to 102-z should be changed accordingly.

In the preferred embodiment, the antenna elements 102-1 to 102-z are installed on front sides of the antenna array cards 152-1 to 152-n and the active components (tuners 104-1 to 104-z and demodulators 106-1 to 106-z, the high frequency tuning sections 205-1 to 205-z, and the low frequency tuning sections 207-1 to 207-n are installed on back sides of the antenna array cards 152-1 to 152-n.

This configuration helps reduce unwanted interference because the active components are located on the opposite sides of the antenna array cards from the antenna elements. Moreover, the active components are contained within an interior space created when the antenna array cards 152-1 to 152-n are installed back to back within the enclosure 150.

Another benefit is that the physical distance between the antenna elements and corresponding active components is reduced over other designs. This reduction in distance between the antenna elements and the active components reduces interference (e.g., electromagnetic interference or EMI) because transmission lines (conductive pathways) are not routed over long distances on the antenna array cards 152-1 to 152-n and left vulnerable to the unwanted interference generated by the active components and/or other transmission lines on the antenna array cards 152-1 to 152-n.

In a preferred embodiment, each antenna element 102-1 to 102-n is comprised of two loop antennas (or antenna element pair), which are shown as a single antenna element in the figures for clarity. In the illustrated example, each loop antenna is approximately 0.5 inches in height, 0.5 inches wide, or about 1 centimeter (cm) by 1 cm, and has a thickness of approximately 0.030 inches, or about a 1 millimeter (mm), in one specific implementation. In terms of the antenna elements, when configured as a square loop, the three-sided length is preferably less than 1.7 inches (4.3 cm), for a total length of all 4 sides being 2.3 inches (5.8 cm), or less.

In one embodiment, the antenna array cards are approximately 25 inches wide by 21 inches long, or about 0.6 meters (m) by 0.5 m. In this embodiment, there is a surface area of about 0.3 m² on each side of the antenna array card 152-1 to 152-n.

Previous implementations of the antenna array cards had 80 antenna elements installed on each card, but the antenna elements were only installed on a small portion of the cards. The remainder of the space was filled with tuners, demodulators, transmission lines, and communication components. Additionally, all of the components were installed on the same side of the antenna array cards.

In the current implementations, greater than 80 antennas are installed on a majority of the front side of each antenna array card 152-1 to 152-n, resulting in a density of greater than 260 antennas per square meter. For example, installing 300 antenna elements results in an antenna density of about 1,000 antenna elements per square meter. In some embodiments, between 250 and 350 (or more) antenna elements could be installed on each antenna array card 152-1 to 152-n. Installing between 250 and 350 antenna elements on each antenna array card 152-1 to 152-n results in an antenna density of 800 to 1,200 antenna elements per square meter.

In general, the number of antenna elements on each antenna array card 152-1 to 152-n and the antenna density are not limited solely by the size of antenna array cards or antenna elements. The number of antenna elements and the antenna density are currently limited by the space required for the active components, transmission lines, and communication components, and the amount of heat generated by the components, which must be dissipated. Thus, while there may be available space on the antenna array cards, there are other factors that must be considered when configuring the cards.

As smaller and/or more efficient components are developed and implemented, more antenna elements are able to be installed the antenna array cards because the smaller components will require less space, need less power, and generate less heat. Thus, it may be possible for future implementations to include 600 (or more) antenna elements on each antenna array card. This results in an antenna density of 2,000 antenna elements per square meter, or more.

Each antenna element 102-1 to 102-n is separately tunable and capable of capturing over the air content from different broadcasting entities with different carrier frequencies. This allows for the simultaneous capturing and/or recording of different (or identical) over the air broadcasts from different broadcasting entities for each of the individual users. Some examples of broadcasting entities include The American Broadcasting Company (ABC), The National Broadcasting Company (NBC), and CBS Broadcasting Inc. (CBS).

Resonance of the antenna elements 102-1 to 102-n is controlled by the low frequency tuning sections 207-1 to 207-z and the high frequency tuning sections 205-1 to 205-z. Generally, one loop of the antenna element is controlled by the low frequency tuning sections 207-1 to 207-z to capture over the air broadcasts in the VHF (very high frequency) range and the other loop is controlled by the high frequency tuning sections 205-1 to 205-z to capture over the air broadcasts in the UHF (ultra high frequency) range.

The tuners 104-1 to 104-z are ATSC (Advanced Television Systems Committee) tuners, in one example. These tuners convert received radio frequency signals to a lower, fixed analog intermediate frequency signal that the demodulators 106-1 to 106-z are able to demodulate.

The demodulators 106-1 to 106-z then demodulate the analog intermediate frequency signal to the MPEG-2 format because it is currently the standard format for the encoding of moving pictures and associated audio information (i.e., broadcast television). In a situation where each broadcast carrier signal contains multiple content transmissions, the ATSC tuners 104-1 to 104-n select the desired program carried on the carrier signal.

In the illustrated example, the demodulators 106-1 to 106-z are mounted on the back side of the antenna array cards 152-1 to 152-n. In an alternative embodiment, the demodulators 106-1 to 106-z could be installed on daughter boards (or daughter cards) to conserve space on the antenna array cards.

Communication sections 107-1 to 107-n of the antenna array cards 152-1 to 152-n transmit the demodulated signals to the encoding system 105 via a data transport 214. In the illustrated embodiment, the communication sections 107-1 to 107-n are installed on back sides the antenna array cards 152-1 to 152-n. In an alternative embodiment, however, the communication sections 107-1 to 107-n could be located on the rear wall of enclosure 150.

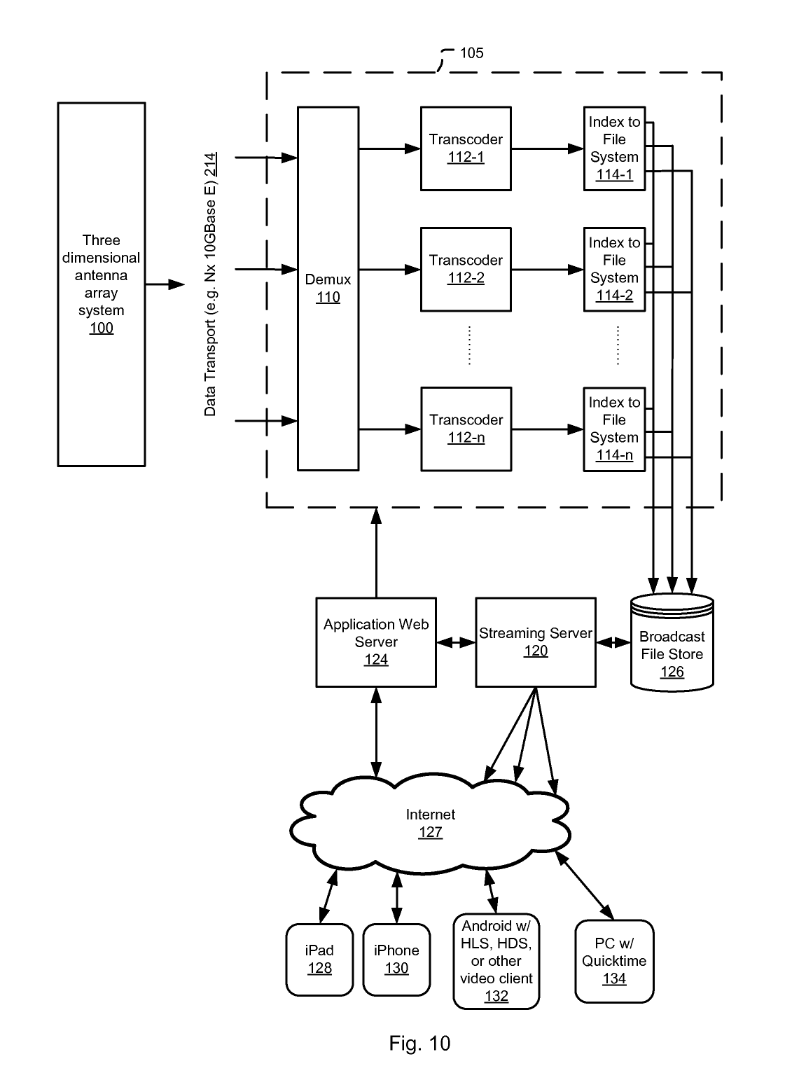

The encoding system 105 is typically located in a secure location such as a ground-level but or the basement of a building. In one example, the demodulated signals are sent to the encoding system 105 via the data transport 214 (e.g., nx10 GbE optical data transport layer). FIG. 10 further illustrates an example of the encoding system 105.

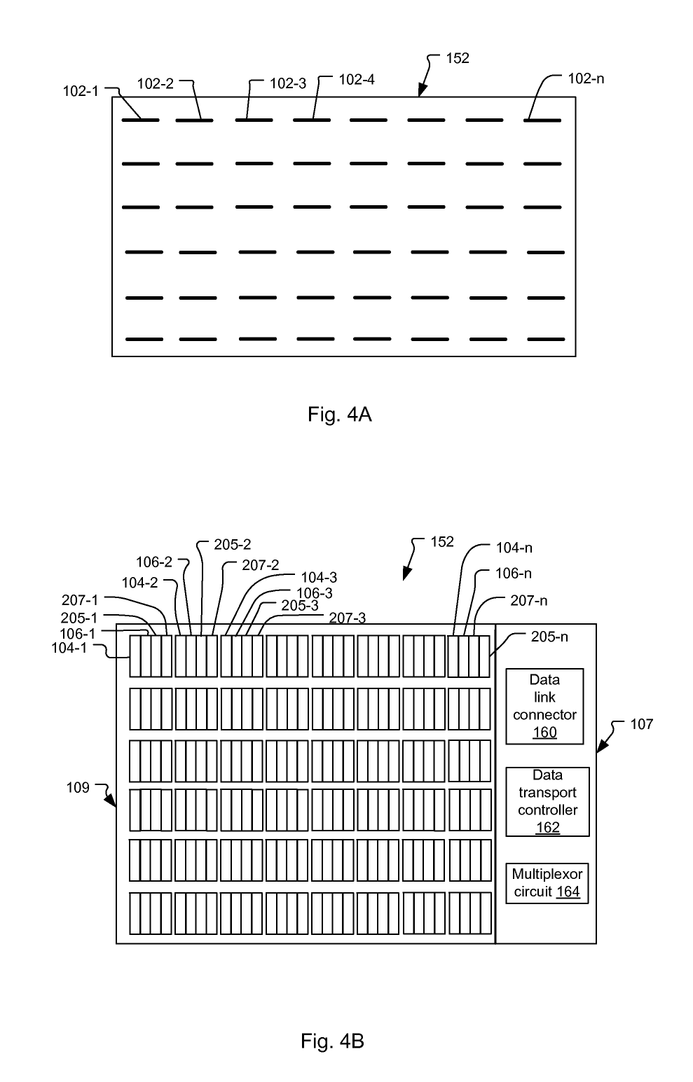

FIG. 4A is a schematic diagram (top view) illustrating antenna elements installed on the front side of the antenna array card 152. This view illustrates how the antenna elements 102-1 to 102-n are arranged in a grid of rows and columns on the antenna array card 152.

While the illustrated example only shows 48 antenna elements installed on the antenna array card 152, one implementation includes approximately 80 to as many as 300 (or more) antenna elements installed on each antenna array card.

FIG. 4B is a schematic diagram illustrating an example of the back side of the antenna array card 152. The tuners 104-1 to 104-n, demodulators 106-1 to 106-n, high frequency tuning sections 205-1 to 205-n, and low frequency tuning sections 207-1 to 207-n are installed within a tuner/demodulator section 109 of the antenna array card. The active components (tuners 104-1 to 104-n and demodulators 106-1 to 106-n) and tuning sections 205-1 to 205-n, 207-1 to 207-n are preferably mounted opposite their corresponding antenna elements. This layout reduces or eliminates long transmission lines because antenna elements and their corresponding tuning sections and active components are installed in close proximity to each other on opposite sides of the antenna array cards.

Communication components are installed in the communication section 107 of the antenna array card. In the illustrated embodiment, the communication components include a data link connector 160, a data transport controller 162, and a multiplexor circuit 164. The multiplexor circuit 164 and data transport controller 162 are used to carry signals to the encoding system 105 via data link connector 160.

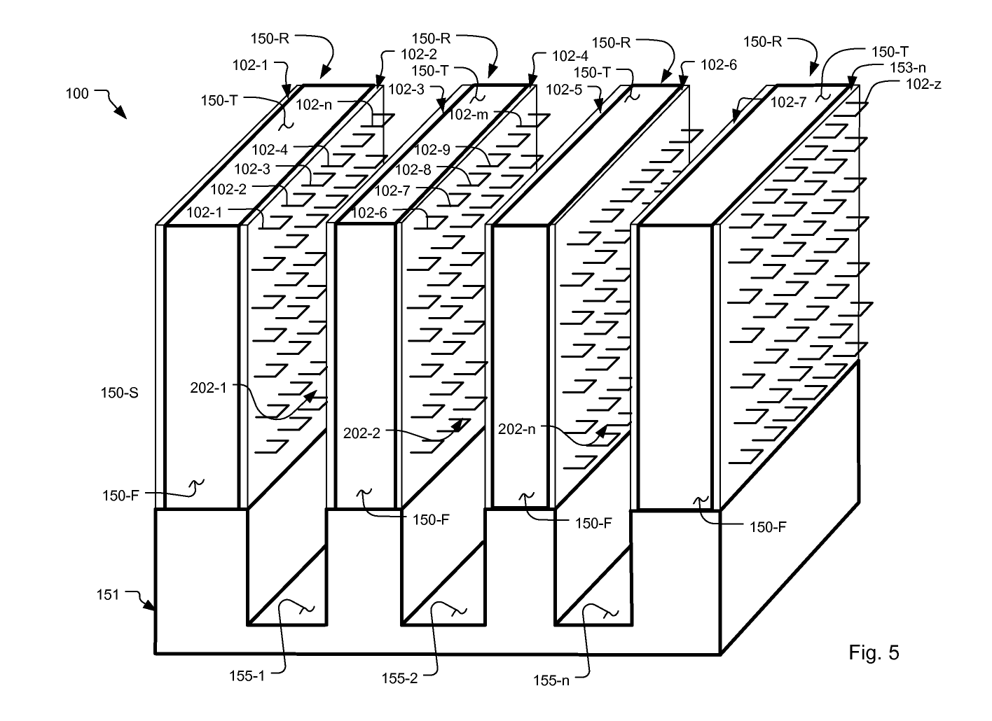

FIG. 5 is a perspective schematic view of a second embodiment of the three dimensional antenna array system 100, which includes troughs 202-1 to 202-n extending through the enclosure 150.

In general, the operation of this embodiment is similar to the example described in FIG. 1. However, rear wall sections of the enclosure 150 are removed enabling the troughs 202-1 to 202-n to extend through the enclosure 150. Additionally, the RF signal absorber blocks (ref. numerals 190-1 to 190-n in FIG. 3) are also removed because there are no rear walls for RF signals to reflect off in this embodiment.

In a typical implementation, a lower enclosure 151 is included to provide structural support for the antenna array cards. Similarly, the communication sections (not shown in the figure) of the antenna array cards must be moved to the bottom of the antenna array cards to be protected within the lower enclosure 151.

This lower enclosure 151 is fabricated from conductive materials to maximize Faraday shielding. To prevent possible short circuits between the conductive material of the lower enclosure 151 and the antenna elements of the antenna array cards, the troughs 202-1 to 202-n also extend downward into a lower enclosure 151 and RF signal absorber blocks 155-1 to 155-n are installed in the bottom of the troughs 201-1 to 202-n.

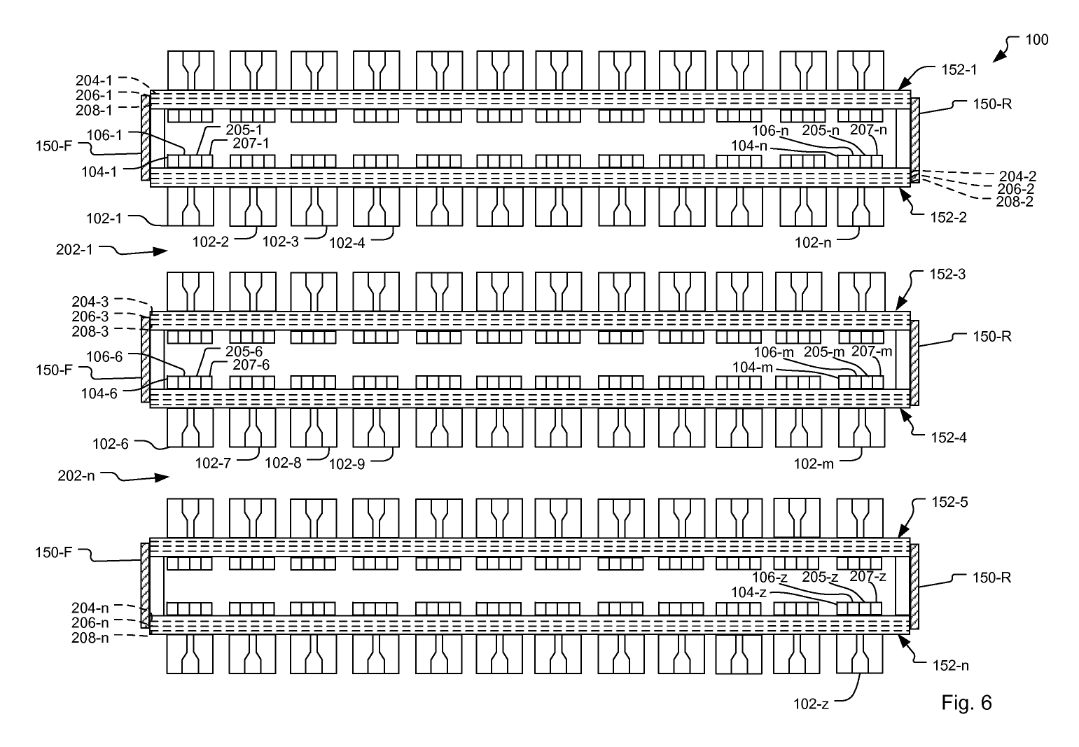

FIG. 6 is a schematic diagram (top view) of the second embodiment of the three dimensional antenna array system 100.

Similar to FIG. 2, the illustrated example only shows a single row of antenna elements, active components, and tuning sections within the enclosure 150 because the antenna elements and active components are arranged in a grid. Additionally, many of the antenna elements, tuning sections, and active components are not labeled to preserve clarity in the figure. The operation of the system 100 is similar to the example illustrated in FIG. 2. In this embodiment, however, sections of the rear wall and the RF signal absorber blocks have been removed to allow the troughs 202-1 to 202-n to extend through the enclosure 150. Thus, the RF signals are able to travel down the troughs and “exit” through the backs of the troughs. That is, the RF signals will not reflect off the rear walls in this embodiment.

This figure also illustrates how antenna array cards are assembled back to back to create a double board. Like the previous example, an interior area for the active components and tuning sections is created.

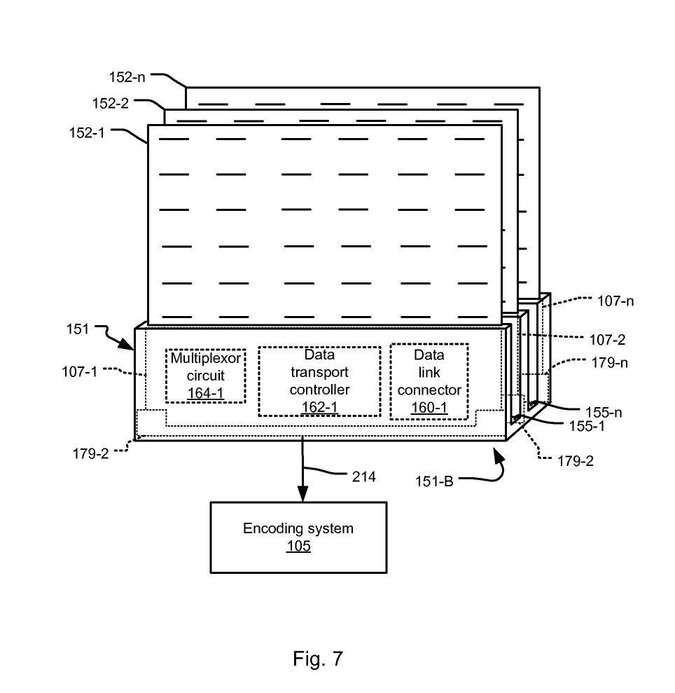

FIG. 7 is a perspective schematic diagram further illustrating the lower enclosure section 151, which acts as a Faraday shield for the communication sections 107-1 to 107-n.

In the illustrated example, the sides, top, front and rear parts of the enclosure 150 are not shown. The illustrated example shows how antenna array cards are supported by the lower enclosure 151 and how the communications sections 107-1 to 107-n are contained within the lower enclosure 151.

The lower enclosure section 151 is typically fabricated as a separate enclosure which attaches to the enclosure 150. In an alternative embodiment, the lower enclosure 151 and the enclosure 150 could be fabricated as a single enclosure. The lower enclosure section 151 protects the communication sections 107-1 to 107-n of the antenna array cards and includes fasteners (e.g., locking tabs) 179-1 to 179-n, which secure the antenna array cards 152-1 to 152-n to the lower enclosure 151. The lower enclosure section 151 generally includes cooling devices such as fans, chiller systems, or heat sinks, to list a few examples.

In this embodiment, the data transport 214 is routed through the bottom 150-B of the lower enclosure section 151 because the communication sections 107-1 to 107-n of the antenna array cards 152-1 to 152-n are located on the bottom of the antenna array cards 152. As in the previous embodiment, the bottom of the lower enclosure 151-B is fabricated from metal mesh.

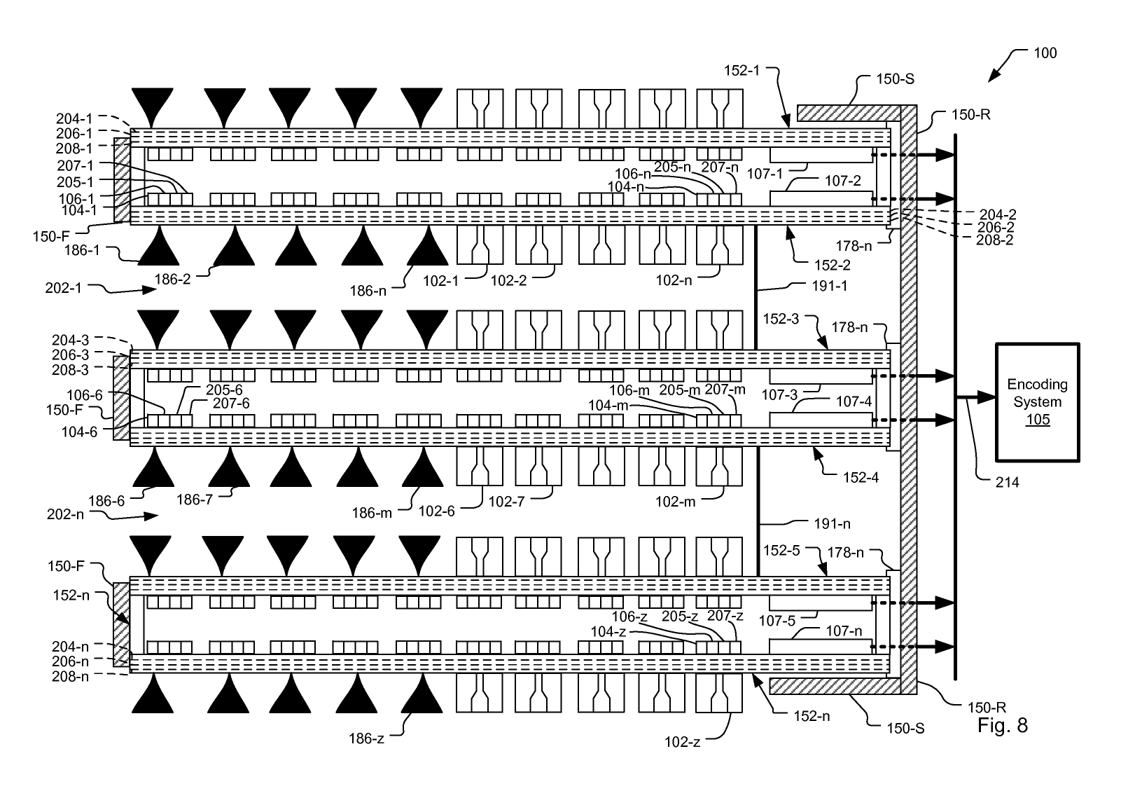

FIG. 8 is a hybrid schematic and block diagram (cross-sectional, top view) of a non-homogeneous three dimensional antenna array also including troughs 202-1 to 202-n formed by the antenna array cards 152-1 to 152-n.

Overall, the configuration and operation of this non-homogeneous three dimensional antenna array is similar to the example illustrated in FIGS. 1-3. In this embodiment, however, electric elements 186-1 to 186-z and magnetic antenna elements 102-1 to 102-z are installed together on the antenna array cards 152-1 to 152-n. Additionally, trough blocks 191-1 to 191-n, located at the ends of the troughs 202, are conductive, rather than absorptive.

In antenna systems that implement a conductive (rather than absorptive) ground plane, the gains of the antenna elements will have nulls (i.e., poor signal reception) at specific distances from the ground plane due to signals reflecting off the trough blocks 191-1 to 191-n and interfering with themselves. By utilizing both magnetic and electric antenna elements, the antenna system includes different types of antenna elements at different distances from the ground plane to avoid the nulls at the specific distances from the ground plane.

In a preferred embodiment, the electric antenna elements 186-1 to 186-n are electric monopole antennas, which should be located less than ½ wavelength from a ground plane of trough blocks 191-1 to 191-n for the expected propagating mode in the enclosure 150. The magnetic elements 102-1 to 102-n are magnetic dipole antennas and should be located less that ¼ wavelength from the ground plane of trough blocks 191-1 to 191-n. This is configured as a short terminated parallel plate waveguide, in one example.

As in the previous examples, the illustrated figure has been simplified for clarity and not all of the antenna elements, active components, and tuning sections have been labeled.

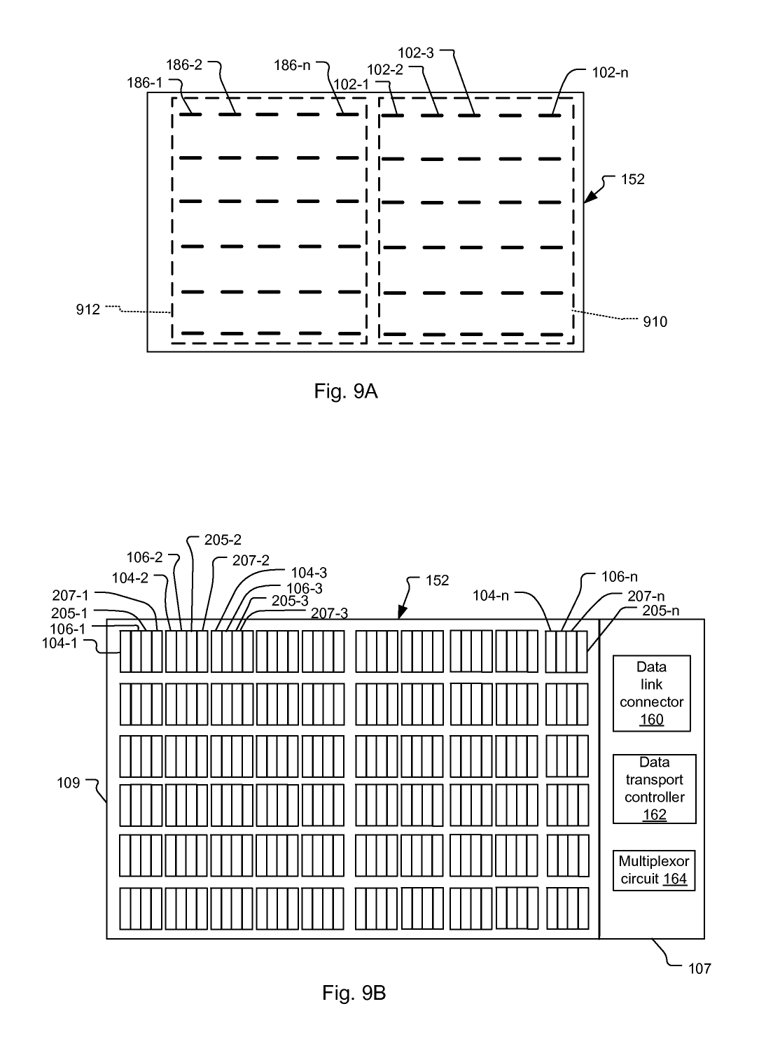

FIG. 9A is a schematic diagram that illustrates the front side of the antenna array card 152 including the magnetic antenna elements 102-1 to 102-n in the magnetic element array 910 and the electric antenna elements 186-1 to 186-n in the electric element array 912.

When viewed from above, both the electrical elements and magnetic elements appear identical. The electric antenna elements 186-1 to 186-n are mounted orthogonal to the magnetic antenna elements 102-1 to 102-n because the magnetic field is orthogonal to the electric field.

While the illustrated example shows 60 antenna elements, a typical antenna array card preferably includes more than 80 to as many as 300 or more antenna elements.

FIG. 9B is a block diagram illustrates the backside of the antenna array card 152 implemented in non-homogeneous antenna arrays.

As in previous examples, each antenna element includes corresponding active components (e.g., tuners 104-1 to 104-n, demodulators 106-1 to 106-n) and tuning sections 205-1 to 205-n, 207-1 to 207-n installed on the backside of the antenna array card. Likewise, the antenna array card 152 further includes communication components (e.g., multiplexor circuit 164, data transport controller 162 and data link connector 160) to carry signals to the encoding system 105.

FIG. 10 is a block diagram illustrating an embodiment of the encoding system 105 for the encoding of captured over the air content.

In a typical implementation, users with client devices 128, 130, 132, 134 access an application web server 124 via packet network(s), which can be private and/or public, such as the Internet 127. In one example, the client device is a personal computer 134 that accesses the server 124 via a browser. The mobile devices are typically tablets or slate computing devices, e.g., iPad mobile computing device, or mobile phones, e.g., iPhone mobile computing device or mobile computing devices running the Android operating system by Google, Inc. Alternatively, many modern game consoles, DVD players, and televisions also have the ability to run third-party software and provide web browsing capabilities. The application web server (or application server) 124 manages user requests from the client devices 128, 130, 132, 134 and relays commands to the encoding system 105.

Captured content transmissions are multiplexed and sent from the antenna array cards 152-1 to 152-n of the three dimensional antenna array system 100 to the encoding system 105 via the data transport 214. The content transmissions are then demultiplexed by the demultiplexor switch 110 for the separate processing pipelines.

Next, the content transmissions from each antenna are transcoded by transcoders 112-1 to 112-n. In the current implementation, the transcoders convert the content transmission to MPEG-4 (also known as H.264) as content transmission data, which is a more efficient format for streaming and/or storing the content transmission data. Typically, multiple transcoding threads run on a single signal processing core, SOC (system on a chip), FPGA or ASIC type device.

The conversion to MPEG-4 format often reduces the picture quality or resolution, but this reduction is generally not noticeable to users on the client devices because of the smaller resolutions of client devices. Similarly, audio of the content transmission is encoded to Advanced Audio Coding (or AAC) in the current embodiment, which is also efficient for streaming and/or storing.

The transcoded content transmission data are sent to a packetizers and indexers 114-1 to 114-n, which packetize and index the content transmission data. In the current embodiment, the packet protocol is UDP (user datagram protocol), which is a stateless, streaming protocol commonly used for streaming content over the Internet. The content transmission data are then transferred to the broadcast file store 126 as content data.

If users request to view live streaming content, then the application server 124 instructs the streaming server 120 to locate the content data in the file store 126 and stream the requested content data to the users. The streaming server 120 (or broadcast file store 126) buffers the requested content data prior to playback to allow the users to pause, rewind, and replay the streaming content data.

In current embodiments, the content data are streamed to the users with HTTP Live Streaming or HTTP Dynamic Streaming. These streaming protocols are dependent upon the client device. HTTP Live Streaming is a HTTP-based media streaming communications protocol implemented by Apple Inc. as part of its QuickTime X and iPhone software systems. The stream is divided into a sequence of HTTP-based file downloads. HDS over TCP/IP is another option. This is an adaptive streaming communications protocol by Adobe System Inc. HDS dynamically switches between streams of different quality based on the network bandwidth and the computing device's resources.

In other embodiments, the content data are streamed using Hypertext Transfer Protocol (HTTP) or Hypertext Transfer Protocol Secure (or HTTPS). HTTPS combines HTTP with the security of Transport Layer Security/Secure Sockets Layer (or TLS/SSL). TLS/SSL are security protocols that provide encryption of data transferred over the Internet.

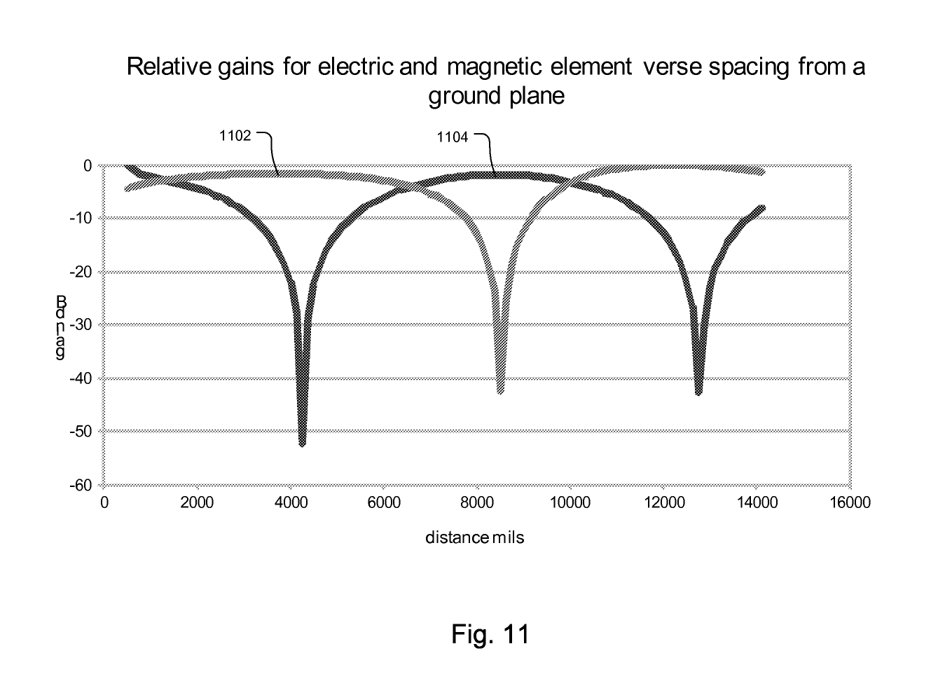

FIG. 11 shows relative gain (in decibels) for a magnetic dipole antenna and an electric antenna element from an infinite ground plane.

A first line 1104 illustrates the relative gain of the magnetic dipole antenna. The gain is directional for an incident plane wave normal to a ground plane. Near the ground plane the gain of the magnetic antenna element is at a maximum. The gain reaches a minimum (or null) at approximately ¼ wavelength from the ground plane. As the distance increases, the gain also increases back to the maximum level. The area beyond this first dip will occur at different angles of incidence, in some implementations.

A second line 1102 illustrates the relative gain of the electric monopole antenna. The gain for the electrical element has a similar dependence, but the minimum (or null) occurs at the ground plane (i.e., a distance of zero wavelengths) and a second minimum occurs at ½ wavelength. The first null does not reoccur at different angles of incidence for distances between 0 and ½ wavelength. However, for distances greater than ½ wavelength, reoccurrences of the null may occur at different angles of incidence, in some implementations.

While this invention has been particularly shown and described with references to preferred embodiments thereof, it will be understood by those skilled in the art that various changes in form and details may be made therein without departing from the scope of the invention encompassed by the appended claims.

What is claimed is:

1. An antenna system comprising:
antenna array cards that include an array of antenna elements disposed on a front side of the cards, the antenna elements being separately tuned to receive over the air broadcasts from broadcasting entities; and
an enclosure that houses the antenna array cards to form troughs with the antenna elements on sides of the troughs.

2. The system according to claim 1, wherein the antenna array cards are installed back to back within the enclosure.

3. The system according to claim 2, wherein the enclosure houses between 6 and 32 antenna array cards.

4. The system according to claim 2, wherein the troughs extend entirely through the enclosure.

5. The system according to claim 1, wherein the antenna array cards include ground planes to reflect the radio frequency signals from the broadcasting entities.

6. The system according to claim 1, further comprising tuners, demodulators, multiplexors, and data link connectors, which are installed on the antenna array cards.

7. The system according to claim 6, wherein the tuners and demodulators are disposed on back sides of the antenna array cards and correspond to the antenna elements disposed on front sides of the cards.

8. The system according to claim 1, wherein the troughs are orientated within the enclosures to maintain a line of sight with one or more transmitters of the broadcasting entities.

9. The system according to claim 1, wherein the antenna elements are polarized to receive the over the air broadcasts from the broadcasting entities.

10. The system according to claim 1, further comprising a radio frequency signal absorbers to prevent reflection of radio waves off walls of the enclosure.

11. The system according to claim 1, wherein top and bottom walls of the enclosure are fabricated from semi-permeable materials that allows air to pass through the material and ventilate the enclosure.

12. A method of capturing over the air broadcasts from broadcasting entities, the method comprising:
on antenna array cards, disposing antenna elements on one side of the cards, the antenna elements separately receiving over the air broadcasts from broadcasting entities; and
arranging the antenna array cards within an enclosure to form troughs with the antenna elements on sides of the troughs.

13. The method according to claim 12, further comprising installing the antenna array cards back to back within the enclosure.

14. The method according to claim 13, housing between 6 and 32 antenna array cards within the enclosure.

15. The method according to claim 13, wherein troughs extend entirely through the enclosure.

16. The method according to claim 12, wherein the antenna array cards include ground planes to reflect the radio frequency signals from the broadcasting entities.

17. The method according to claim 12, wherein the antenna array cards include tuners, demodulators, multiplexors, and data link connectors installed on the antenna array card.

18. The method according to claim 17, wherein the tuners and demodulators are disposed on back sides of the antenna array cards and correspond to the antenna elements disposed on front sides of the cards.

19. The method according to claim 12, further comprising orientating the troughs of antenna elements to maintain a line of sight with one or more transmitters of the broadcasting entities.

20. The method according to claim 12, wherein the antenna elements are polarized to receive the over the air broadcasts from the broadcasting entities.

21. The method according to claim 12, wherein the enclosures include a radio frequency signal absorbers to prevent unwanted radio frequency from reflecting off walls of the enclosure.

22. The method according to claim 12, wherein top and bottom walls of the enclosure are fabricated from semi-permeable materials that allows air to pass through the material and ventilate the enclosure.

23. An antenna array card comprising:
an array of antenna elements disposed on a front side of the cards; and
corresponding tuners and demodulators disposed on a back side of the card; and
wherein the antenna elements are separately tuned by the tuners to receive over the air broadcasts from broadcasting entities.

24. The antenna array card of claim 23, wherein the demodulators convert the over the air broadcasts into MPEG-2 format.

25. The antenna array card of claim 23, wherein the tuner includes high frequency tuning sections and low frequency tuning sections.

26. An antenna system comprising:
antenna array cards that include an array of antenna elements disposed on a front side of the cards, the antenna elements separately tuned to receive over the air broadcasts from broadcasting entities; and
an enclosure that positions the antenna array cards back to back within the enclosure to form troughs with the antenna elements on opposed sides of the troughs.

27. An antenna system comprising:
antenna array cards that include electric and magnetic antenna elements installed on front sides of the cards, the antenna elements separately tunable to receive over the air broadcasts from different broadcasting entities; and
wherein the magnetic antenna elements are installed on the antenna array cards closer to a ground plane than the electric antenna elements.

28. The system according to claim 27, wherein the magnetic antenna elements are installed at a distance of less than ¼ wavelength from the ground plane.

29. The system according to claim 27, wherein the electric antenna elements are installed less than ½ wavelength from the ground plane.
